(19) United States
(12) Patent Application Publication
(10) Pub. No.: US 2024/0056226 A1
(43) Pub. Date: Feb. 15, 2024

(54) ADAPTIVE HARQ SELECTION IN HIGH DENSITY ENVIRONMENTS

(71) Applicant: Cisco Technology, Inc., San Jose, CA (US)

(72) Inventors: Ardalan ALIZADEH, Milpitas, CA (US); Sivadeep Reddy KALAVAKURU, Akron, OH (US); Matthew Aaron SILVERMAN, Shaker Heights, OH (US); John Matthew SWARTZ, Lithia, FL (US)

(73) Assignee: Cisco Technology, Inc., San Jose, CA (US)

(21) Appl. No.: 17/818,419

(22) Filed: Aug. 9, 2022

(51) Int. Cl. H04L 1/18; H04L 1/08; H04W 16/28

(52) U.S. Cl. CPC H04L 1/1812; H04L 1/08; H04W 16/28

(57) ABSTRACT

A network of access points (AP) in a high-density environment may be provided. A number of packet transmission retries for one or more of the AP may be determined by setting a number, m, of retries for transmitting a data packet, where m is the upper limit of the number of retries. Data packets are then transmitted m times. Upon transmitting the data packet m times, a success probability SP(u,m) for transmission of the data packet, where u is the number of users, may be calculated. The transmission of the data packet may be repeated m−x times where x is an integer. Upon calculating the success probability for m−x times, a success probability SP(u,m−x) for transmission of the data packet may be calculated. If SP (u,m−x) is larger than SP(u,m) then x may be decreased by one and actions (b)-(f) may be repeated. If SP (u,m−x) is not larger than SP(u,m) then m−x may be set as the maximum number of retries for the data packet.

### TECHNICAL FIELD

This patent document relates hybrid automatic repeat requests (HARQ), and more particularly to adaptive HARQ requests in high density environments.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

FIG. 1 illustrates an environment with a high density of access points.

FIG. 2 is a flow chart of a process for optimizing the maximum number or retransmissions or retries.

FIG. 3 is a block diagram of a computing device.

### DETAILED DESCRIPTION

### Overview

A network of access points (AP) in a high-density environment may be provided. A number of packet transmission retries for one or more of the AP may be determined by setting a number, m, of retries for transmitting a data packet, where m is the upper limit of the number of retries. Data packets are then transmitted m times. Upon transmitting the data packet m times, a success probability SP(u,m) for transmission of the data packet, where u is the number of users, may be calculated. The transmission of the data packet may be repeated m minus x (m−x) times where x is an integer. Upon calculating the success probability for m−x times, a success probability SP(u,m−x) for transmission of the data packet may be calculated. If SP (u,m−x) is larger than SP(u,m) then x may be decreased by one and actions (b)-(f) may be repeated. If SP (u,m−x) is not larger than SP(u,m) then m−x may be set as the maximum number of retries for the data packet.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

In WiFi networks, if a control sum of a packet does not equal the value in the corresponding field of the packet, the receiver drops the obtained data, and the transmitter repeats the whole packet. To improve spectrum efficiency of IEEE 802.11 be, many contributions proposed to introduce HARQ to 11 be.

In contrast to the legacy retransmission procedure, hybrid automatic repeat requests (HARQ) exploits information from the previous tries. The receiver combines the signals from several transmission attempts, which increases signal-to-noise ratio (SNR) and, consequently, the probability that the receiver decodes the packet correctly.

TGbe has discussed three popular HARQ methods: Chase Combining (CC), Punctured CC, and incremental Redundancy (IR). With CC, every retry contains the same information as the initial transmission. With Punctured CC, the transmitter repeats only a portion of the coded bits that have low SNR. With IR, every retransmission uses a different set of coded bits, representing the same set of information bits.

Packet loss occurs for various reasons, including problems in the physical or MAC layer. The causes of packet loss can be classified into three categories: physical factors, such as signal strength, noise and multipath effect; contention for medium access; and buffer overflow due to network congestion or buffer bloat due to an excessive queue memory. These packet losses can be for several reasons depending on the deployment environment e.g., coexist/interference with non-WiFi networks, channel fading, hidden nodes and collisions.

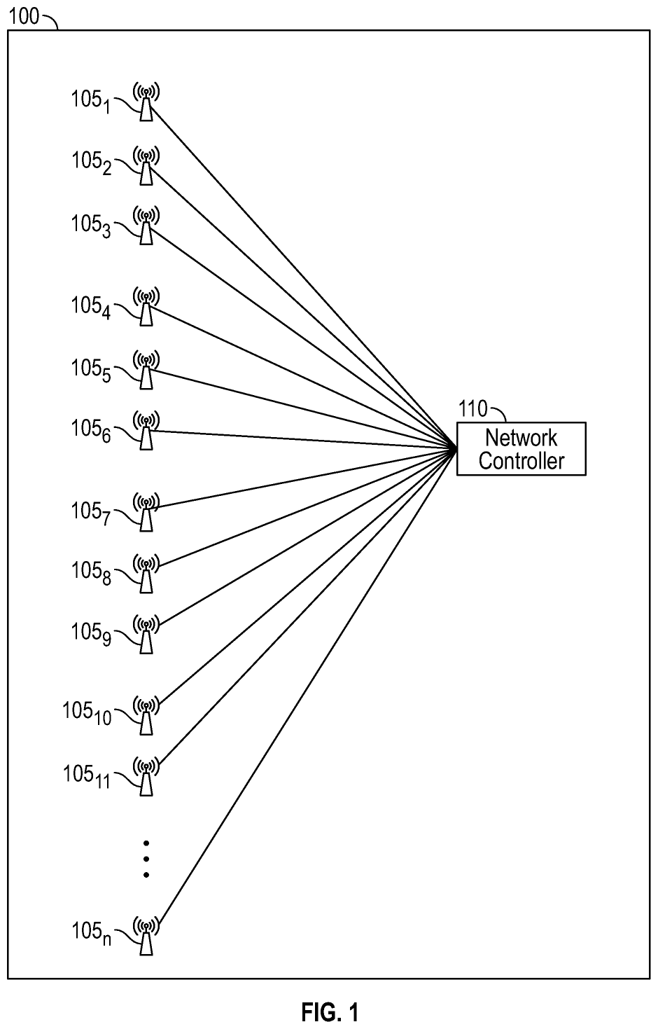

Referring to FIG. 1, venues 100 such as stadiums, arenas, malls, theater complexes, fair grounds, and other large venues can have very dense networks of access points (AP) 105₁-105ₙ. For example, these APs 105₁-105ₙ can be spaced throughout the venue and separated by a distance of only 20 feet or less. These AP's 105₁-105ₙ can be linked to and controlled by one or more network controllers 110.

With such a high-density network 100, collisions can become major issue. Usually, a communication channel has three states: busy due to a transmission, busy because of a collision, and idle. In the first state, the channel remains busy while successful transmission is occurring, and only the sender has permission to access the medium. In the second state, the channel remains unavailable because of a collision, and in the last state, the channel is available to new transmissions. Collision can happen due to hidden node occurrence too. A hidden node occurs when nodes outside other nodes' carrier-sensing ranges are nevertheless close enough to interfere with each other.

Every station maintains a station short retry count (SSRC) as well as a station long retry count (SLRC), both of which take an initial value of zero for every new packet. The short retry count indicates the maximum number of retransmission attempts of a request to send (RTS) packet with a clear to send (CTS) packet, or of a data packet when RTS/CTS is not used. The long retry count indicates the maximum number of retransmission attempts of a data packet when RTS/CTS is used. When either of these limits is reached, retry attempts cease and the packet is discarded

It is shown that the interference is temporally correlated because it comes from the same set of interferers in different time slots. Such correlation makes the link success events temporally correlated and thus dramatically affecting the network performance.

Delay-Limited Throughput (DLT) is a well-known metric accounts for the times of retransmission which gives an accurate rate of transmission as shown in Equation (1):

DLT(k,u)=R(u)/1·SP(u,1)+R(u)/2*SP(u,2)+ . . . +R(u)Im*SP(u,m) (1)
where DLT(k,u) is the delay-limited throughput of k-th AP for u-th client; SP(u,m) is the success probability in m-th retransmission for link between AP k and client u; m is the maximum number of allowed retransmission and R(u) is the rate of u-th client. This equation implies that when the success probability in each try is higher, the total goodput of will increase but the larger m may not improve the DLT significantly specially when SP is low for larger m.

Additionally, the impact of temporal interference correlation is cumulative as the number of retransmission attempts increases. For instance, an increase in the number of retransmission attempts causes an aggravated impact of temporal interference correlation on network ST.

In a typical deployment with normal user density, for example, packet failures usually happen because of drops in SNR or received signal strength indicator (RSSI) for a media convergence server (MCS) that was chosen. In such situations, HARQ can provide benefits by combining the soft information from each retransmission, which at the end of combining the transmissions will show itself as a higher SNR.

In a very dense environments such as stadium deployments, however, a network of APs normally does not suffer from weak signals (e.g., low SNR) because the cell size for each AP is small and may use a directional antenna such as the Marlin® 4 antenna, which is commercially available from Cisco Systems, Inc. having it principal place of business in San Jose, California. Such high-density deployments, however, may have correlated/bursty interference and collisions that causes too many packets to be lost and a large number of retransmissions.

Additionally, selecting a maximum number of retransmissions is not a trivial task in a dense network such as those networks that may be found in stadiums, arenas, malls, fair grounds, or other such venues. For example, increasing the number of maximum retransmissions to a large number of clients in a dense network may degrade the performance of the entire network 100 because the large number of reties increases the channel contention and the probability of collision. These problems are not important in normal or low-density environments because AP's in such networks rarely reach the maximum retries (usually once per MCS and link adaptation period).

As disclosed herein, there are at least several systems and methods to optimize the performance of networks based on adaptive HARQ adjustments. In at least one example system and method, for example, a maximum number of retries that is optimal for a dense network of APs is determined.

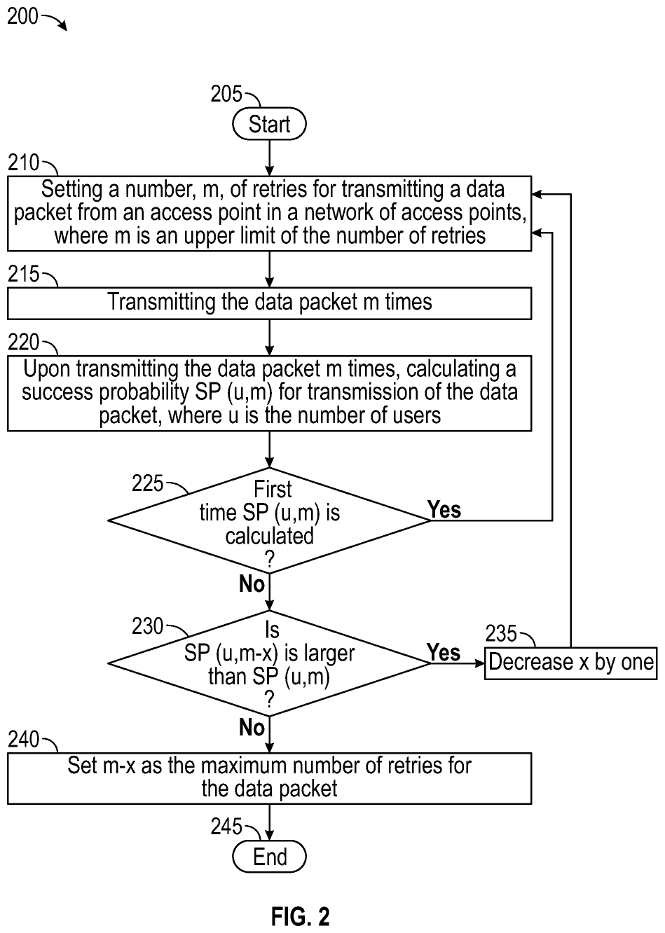

FIG. 2 illustrates a process 200 of optimizing the maximum number or retransmissions or retries. The process starts at 205. In this example, the maximum number retries (m) for transmitting a data packet from an AP in a network of APs is set, where m is an upper limit of the number of retries. Operation 210. The data packet is then transmitted m times. Operation 215. Upon transmitting the data packet m times, a success probability SP(u,m) is calculated for transmission of the data packet. Operation 220. This number of retries can be considered a large number, e.g. m=10. The SP(u,m) is calculated based on the ratio of successfully decoded packets in m-th transmission for user u. In this operation, there might be no information for a larger m, in which case the value of the SP(u,m) may be set to zero. A new metric based is then based on collected SP(u,m) to set a condition. This metric, m, can be determined by averaging the SP (u, m) among all access users connected to an AP. In an alternative embodiment, the metric can be determined based on the user having the lowest probability of success for receiving a data packet (e.g., the user that is realizing the lowest SP(u,m)).

The maximum number of retries then is set to the largest m which provides a non-zero SP. For example, SP can be (0.80, 0.88, 0.90, 0.95) for four successive retries, which means that there is a 95% probability there will be a successful transmit of the data packet on the fourth retry and m is set to 4.

If operation 220 is the first time SP(u,m) is calculated, reduce m by one, and then return to Operation 210 and recalculate SP(u,m). Operation 225. If operation 220 is not the first time SP(u,m) is calculated, compare the m-th SP with the m-th SP previously calculated in Operation 230. If the most recent calculation of SP is larger than previous calculated value of SP, it means that interference has been reduced, and the value of m should be reduced by one a value of one (1). Operation 235. The process of determining the maximum number of transmissions retires then returns to Operation 210. If the m-th value of SP(u,m) has not changed, the maximum number of retries for the access point is set to the most recent value of m, Operation 240, and the process ends, Operation 245. For example the values of SP can be calculated to be (0.80, 0.88, 0.98) in one iteration of the process and the values of SP can be calculated to be (0.80, 0.88) in the next iteration of the process. In this example scenario, there is no benefit in terms of reducing the temporal interference by reducing the value of m to 2 and M=3 is optimal.

In other example embodiments, the SNR may not be an issue causing meaningful packet loss in an environment of dense AP, and enabling HARQ may not be beneficial. Because HARQ is a memory-hungry and complex process, it may be desirable to disable HARQ in these situations.

For this purpose, reasons for the packet failure are identified. For downlinks, the AP stores the number of retransmission and the RSSI of the client can be captured by 802.11k. A resource pool manager (RPM) requests the number of retries from the AP.

For the uplink, physical layer metrics such as per orthogonal frequency-division multiple (OFDM) symbol, SNR, and error vector magnitude (EVM) are calculated to identify the bursty interference from low signal power.

The decision to selectively disable HARQ can be made by individual APs. Alternatively, the decision to disable HARQ can be made to a central unit such as a network controller.

Additional example embodiments that may further improve the efficiency of HARQ in a dense network include random beamforming and power-controlled transmissions or retries. In a dense network, beamforming can be a tedious task because of the huge amount of overhead required for channel sounding, which can cause large channel contention and delays. However, in the combination with HARQ, randomized beamforming can be used for each retransmission. Beamforming can be used in both the downlink and uplink directions. This process can increase the chance of correct detection for both channel diversity and spatial diversity.

A benefit of this randomization is to reduce the probability of a transmission colliding with another transmission. Additionally, increasing randomness in the set of interferers may be capable of alleviating temporal interference correlation. Additionally, random beamforming, can provide a lower or higher SNR in the range of the beamforming gain, which can increase the total goodput of the network.

In power-controlled retransmissions, the transmit power for the AP may be gradually increased in each successive retransmission. This process may reduce the probability of collision between transmissions while we increase the chance of correct reception in a shorter number of retries. The minimum power in the first transmission can be selected such that it does not jeopardize the reception of selected MCS. The power step size is calculated based on the difference between a maximum allowable or possible power level and a minimum power level in the first transmission divided by a maximum number of retires.

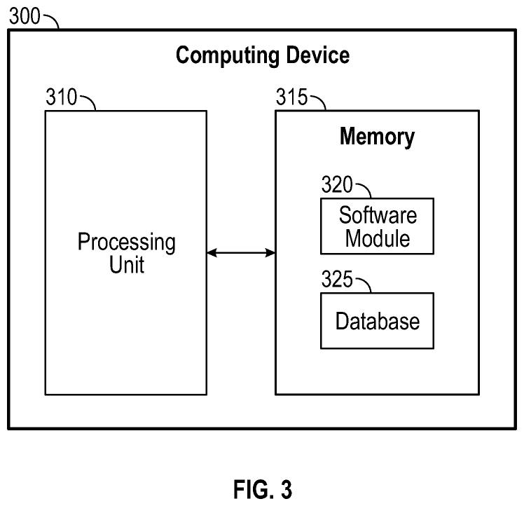

FIG. 3 shows a computing device 300. As shown in FIG. 3, computing device 300 may include a processing unit 310 and a memory unit 315. Memory unit 315 may include a software module 320 and a database 325. While executing on processing unit 310, software module 320 may perform, for example, processes describe in more detail herein.

Computing device 300 may be implemented using a Wi-Fi access point, a tablet device, a mobile device, a smart phone, a telephone, a remote-control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general-purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The systems, methods, and computer-readable medium disclosed herein have many aspects including the following.

One aspect is a system for adaptive HARQ selection in high density environments. The system comprises a memory storage and a processing unit. The processing unit is disposed in a station and in data communication with the memory storage. The processing unit is operative to determine the number of packet transmission retries for an access point (AP) in a network of access points, the number of packet transmission retries being determined by (a) setting a number, m, of retries for transmitting a data packet, where m is an upper limit of the number of retries; (b) transmitting the data packet m times; (c) upon transmitting the data packet m times, calculating a success probability SP(u,m) for transmission of the data packet, where u is the number of users; and (d) setting the maximum number of retries to the largest value of m that provides a non-zero value for the success probability SP(u,m).

Another aspect is a system, alone or in any combination with the previous embodiments and aspects disclosed herein, wherein setting the maximum number of retries comprises: (e) repeating the transmission of the data packet m−x times where x is an integer; (f) upon calculating the success probability for m−x times, calculating a success probability SP(u,m−x) or transmission of the data packet; and (g) if SP (u,m−x) is larger than SP(u,m) then decrease x by one and repeat actions (b)-(g), if SP (u,m−x) is not larger than SP(u,m) then setting m−x as the maximum number of retries for the data packet.

Another aspect is a system, alone or in any combination with the previous embodiments and aspects disclosed herein, wherein the processing unit is further operative to store the number of retransmissions of each access point and if the number of downloads for a particular access point exceeds a determined number, then disable hybrid automatic repeat requests (HARQ) at that particular access point.

Another aspect is a system, alone or in any combination with the previous embodiments and aspects disclosed herein, wherein the processing unit is further operative to: calculate a metric selected from the group consisting essentially of an orthogonal frequency division multiplex (OFDM) symbol, a signal-to-noise ratio (SNR), or an error vector magnitude (EVM), or combinations thereof; and disable hybrid automatic repeat requests (HARQ) at the access point if the metric exceeds a determined value.

Another aspect is a system, alone or in any combination with the previous embodiments and aspects disclosed herein, wherein the processing unit is further operative to disable hybrid automatic repeat requests (HARQ) for two or more access points in a network of access points if the metric exceeds a determined value.

Another aspect is a system, alone or in any combination with the previous embodiments and aspects disclosed herein, wherein the access point comprises an antenna and the processing unit is further operative to beamform transmissions of a data packet from the antenna in one direction and beamform transmission of the data packet from the antenna in a different direction for a different transmission of the data packet.

Another aspect is a system, alone or in any combination with the previous embodiments and aspects disclosed herein, wherein the access point comprises and antenna and is configured to transmit the packet through the antenna at a determined transmit power, the processing unit further operative to control the access point to increase the transmit power for each retransmission of the data packet.

Another aspect is a method, alone or in any combination with the previous embodiments and aspects disclosed herein, comprising: (a) setting a number, m, of retries for transmitting a data packet from an access point in a network of access points, where m is an upper limit of the number of retries; (b) transmitting the data packet m times; (c) upon transmitting the data packet m times, calculating a success probability SP(u,m) for transmission of the data packet, where u is the number of users; and (d) setting the maximum number of retries to the largest value of m that provides a non-zero value for the success probability SP(u,m).

Another aspect is a method, alone or in any combination with the previous embodiments and aspects disclosed herein, wherein setting the maximum number of retries comprises: (e) repeating the transmission of the data packet m−x times where x is an integer; (f) upon calculating the success probability for m−x times, calculating a success probability SP(u,m−x) for transmission of the data packet; and (g) if SP (u,m−x) is larger than SP(u,m) then decrease x by one and repeat actions (b)-(g), if SP (u,m−x) is not larger than SP(u,m) then setting m−x as the maximum number of retries for the data packet.

Another aspect is a method, alone or in any combination with the previous embodiments and aspects disclosed herein, further comprising storing the number of retransmissions of each access point and if the number of downloads for a particular access point exceeds a determined number, then disabling hybrid automatic repeat requests (HARQ) at that particular access point.

Another aspect is a method, alone or in any combination with the previous embodiments and aspects disclosed herein, further comprising: calculating a metric selected from the group consisting essentially of an orthogonal frequency division multiplex (OFDM) symbol, a signal-to-noise ratio (SNR), or an error vector magnitude (EVM), or combinations thereof; and disabling hybrid automatic repeat requests (HARQ) at the access point if the metric exceeds a determined value.

Another aspect is a method, alone or in any combination with the previous embodiments and aspects disclosed herein, wherein disabling hybrid automatic repeat requests (HARQ) at the access point comprises disabling hybrid automatic repeat requests (HARQ) for two or more access points in a network of access points if the metric exceeds a determined value.

Another aspect is a method, alone or in any combination with the previous embodiments and aspects disclosed herein, further comprising beamforming transmissions of a data packet from an antenna of the access point in one direction; and beamforming transmission of the data packet from the antenna in a different direction for a different transmission of the data packet.

Another aspect is a method, alone or in any combination with the previous embodiments and aspects disclosed herein, further comprising: transmitting the packet through the antenna at a determined transmit power; and controlling the access point to increase the transmit power for each retransmission of the data packet.

Another aspect is a computer-readable medium, alone or in any combination with the previous embodiments and aspects disclosed herein, the computer-readable medium that stores a set of non-transitory instructions that when executed perform a method executed by the set of instructions, comprising: (a) setting a number, m, of retries for transmitting a data packet from an access point in a network of access points, where m is an upper limit of the number of retries; (b) transmitting the data packet m times; (c) upon transmitting the data packet m times, calculating a success probability SP(u,m) for transmission of the data packet, where u is the number of users; repeating the transmission of the data packet m−x times where x is an integer; (e) upon calculating the success probability for m−x times, calculating a success probability SP(u,m−x) for transmission of the data packet; and (f) if SP (u,m−x) is larger than SP(u,m) then decrease x by one and repeat actions (b)-(f), if SP (u,m−x) is not larger than SP(u,m) then setting m−x as the maximum number of retries for the data packet.

Another aspect is a computer-readable medium, alone or in any combination with the previous embodiments and aspects disclosed herein, the computer-readable medium that stores a set of non-transitory instructions that when executed perform a method executed by the set of instructions, further comprising storing the number of retransmissions of each access point and if the number of downloads for a particular access point exceeds a determined number then disabling hybrid automatic repeat requests (HARQ) at that particular access point.

Another aspect is a computer-readable medium, alone or in any combination with the previous embodiments and aspects disclosed herein, the computer-readable medium that stores a set of non-transitory instructions that when executed perform a method executed by the set of instructions, further comprising: calculating a metric selected from the group consisting essentially of an orthogonal frequency division multiplex (OFDM) symbol, a signal-to-noise ratio (SNR), or an error vector magnitude (EVM), or combinations thereof; and disabling hybrid automatic repeat requests (HARQ) the access point if the metric exceeds a determined value.

Another aspect is a computer-readable medium, alone or in any combination with the previous embodiments and aspects disclosed herein, the computer-readable medium that stores a set of non-transitory instructions that when executed perform a method executed by the set of instructions, wherein disabling hybrid automatic repeat requests (HARQ) at the access point comprises disabling hybrid automatic repeat requests (HARQ) at two or more access points.

Another aspect is a computer-readable medium, alone or in any combination with the previous embodiments and aspects disclosed herein, the computer-readable medium that stores a set of non-transitory instructions that when executed perform a method executed by the set of instructions, further comprising: beamforming transmissions of a data packet from an antenna of the access point in one direction; and beamforming transmission of the data packet from the antenna in a different direction for a different transmission of the data packet.

Another aspect is a computer-readable medium, alone or in any combination with the previous embodiments and aspects disclosed herein, the computer-readable medium that stores a set of non-transitory instructions that when executed perform a method executed by the set of instructions, further comprising: transmitting the packet through the antenna at a determined transmit power; and controlling the access point to increase the transmit power for each retransmission of the data packet.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure

What is claimed is:

1. A system comprising:
a memory storage: and
a processing unit, the processing unit disposed in a station and in data communication with the memory storage, the processing unit operative to determine a number of packet transmission retries for an access point (AP) in a network of access points, the number of packet transmission retries being determined by:
(a) setting a number, m, of retries for transmitting a data packet, where m is an upper limit of the number of retries;
(b) transmitting the data packet m times;
(c) upon transmitting the data packet m times, calculating a success probability SP(u,m) for transmission of the data packet, where u is a number of users; and
(d) setting a maximum number of retries to the largest value of m that provides a non-zero value for the success probability SP(u,m).

2. The system of claim 1 wherein setting the maximum number of retries comprises:
(e) repeating the transmission of the data packet m−x times where x is an integer;
(f) upon calculating the success probability for m−x times, calculating a success probability SP(u,m−x) for transmission of the data packet; and
(g) if SP (u,m−x) is larger than SP(u,m) then decrease x by one and repeat actions (b)−(g), if SP (u,m−x) is not larger than SP(u,m) then setting m−x as the maximum number of retries for the data packet.

3. The system of claim 1 wherein the processing unit is further operative to store a number of retransmissions of each access point and if a number of downloads for a particular access point exceeds a determined number then disable hybrid automatic repeat requests (HARQ) at that particular access point.

4. The system of claim 1 wherein the processing unit is further operative to:
calculate a metric selected from the group consisting essentially of an orthogonal frequency division multiplex (OFDM) symbol, a signal-to-noise ratio (SNR), or an error vector magnitude (EVM), or combinations thereof; and
disable hybrid automatic repeat requests (HARQ) at the access point if the metric exceeds a determined value.

5. The system of claim 4 wherein the processing unit is further operative to disable hybrid automatic repeat requests (HARQ) for two or more access points in a network of access points if the metric exceeds a determined value.

6. The system of claim 1 wherein the access point comprises an antenna and the processing unit is further operative to beamform transmissions of a data packet from the antenna in one direction and beamform transmission of the data packet from the antenna in a different direction for a different transmission of the data packet.

7. The system of claim 1 wherein the access point comprises and antenna and is configured to transmit the packet through the antenna at a determined transmit power, the processing unit further operative to control the access point to increase the transmit power for each retransmission of the data packet.

8. A method comprising:
(a) setting a number, m, of retries for transmitting a data packet from an access point in a network of access points, where m is an upper limit of the number of retries;
(b) transmitting the data packet m times;
(c) upon transmitting the data packet m times, calculating a success probability SP(u,m) for transmission of the data packet, where u is a number of users; and
(d) setting the maximum number of retries to the largest value of m that provides a non-zero value for the success probability SP(u,m).

9. The method of claim 8 wherein setting the maximum number of retries comprises:
(e) repeating the transmission of the data packet m−x times where x is an integer;
(f) upon calculating the success probability for m−x times, calculating a success probability SP(u,m−x) for transmission of the data packet; and
(g) if SP (u,m−x) is larger than SP(u,m) then decrease x by one and repeat actions (b)-(g), if SP (u,m−x) is not larger than SP(u,m) then setting m−x as the maximum number of retries for the data packet.

10. The method of claim 8 further comprising storing a number of retransmissions of each access point and if a number of downloads for a particular access point exceeds a determined number then disabling hybrid automatic repeat requests (HARQ) at that particular access point.

11. The method of claim 8 further comprising:
calculating a metric selected from the group consisting essentially of an orthogonal frequency division multiplex (OFDM) symbol, a signal-to-noise ratio (SNR), or an error vector magnitude (EVM), or combinations thereof; and
disabling hybrid automatic repeat requests (HARQ) at the access point if the metric exceeds a determined value.

12. The method of claim 11 wherein disabling hybrid automatic repeat requests (HARQ) at the access point comprises disabling hybrid automatic repeat requests (HARQ) for two or more access points in a network of access points if the metric exceeds a determined value.

13. The method of claim 8 further comprising
beamforming transmissions of a data packet from an antenna of the access point in one direction; and
beamforming transmission of the data packet from the antenna in a different direction for a different transmission of the data packet.

14. The method of claim 8 further comprising:
transmitting the packet through an antenna at a determined transmit power; and
controlling the access point to increase the transmit power for each retransmission of the data packet.

15. A computer-readable medium that stores a set of non-transitory instructions that when executed perform a method executed by the set of instructions comprising:
(a) setting a number, m, of retries for transmitting a data packet from an access point in a network of access points, where m is an upper limit of the number of retries;
(b) transmitting the data packet m times;
(c) upon transmitting the data packet m times, calculating a success probability SP(u,m) for transmission of the data packet, where u is a number of users;
(d) repeating the transmission of the data packet m−x times where x is an integer;
(e) upon calculating the success probability for m−x times,
calculating a success probability SP(u,m−x) for transmission of the data packet; and
(f) if SP (u,m−x) is larger than SP(u,m) then decrease x by one and repeat actions (b)-(f), if SP (u,m−x) is not larger than SP(u,m) then setting m−x as the maximum number of retries for the data packet.

16. The computer-readable medium of claim 15 further comprising storing a number of retransmissions of each access point and if a number of downloads for a particular access point exceeds a determined number then disabling hybrid automatic repeat requests (HARQ) at that particular access point.

17. The computer-readable medium of claim 15 further comprising:
calculating a metric selected from the group consisting essentially of an orthogonal frequency division multiplex (OFDM) symbol, a signal-to-noise ratio (SNR), or an error vector magnitude (EVM), or combinations thereof; and
disabling hybrid automatic repeat requests (HARQ) the access point if the metric exceeds a determined value.

18. The computer-readable medium of claim 17 wherein disabling hybrid automatic repeat requests (HARQ) at the access point comprises disabling hybrid automatic repeat requests (HARQ) at two or more access points.

19. The computer-readable medium of claim 15 further comprising:
beamforming transmissions of a data packet from an antenna of the access point in one direction; and
beamforming transmission of the data packet from the antenna in a different direction for a different transmission of the data packet.

20. The computer-readable medium of claim 15 further comprising:
transmitting the packet through an antenna at a determined transmit power; and
controlling the access point to increase the transmit power for each retransmission of the data packet.
